(19) United States
(12) Patent Application Publication
(10) Pub. No.: US 2024/0001376 A1
(43) Pub. Date: Jan. 4, 2024

(54) REVERSIBLE BIPOLARIZATION IONIZER

(71) Applicant: Carrier Corporation, Palm Beach Gardens, FL (US)

(72) Inventors: Michael Birnkrant, Manlius, NY (US); Hongsheng Liu, Pudong New Area (CN); Huanan Li, Pudong New Area (CN); Yan Yu, Pudong New Area (CN); Ronghai Hu, Pudong New Area (CN); Zhiwang Guo, Pudong New Area (CN)

(21) Appl. No.: 18/342,773

(22) Filed: Jun. 28, 2023

Related U.S. Application Data
(60) Provisional application No. 63/356,779, filed on Jun. 29, 2022.

(51) Int. Cl. B03C 3/68; H01T 23/00; B03C 3/41; B03C 3/86; B03C 3/04

(52) U.S. Cl. CPC B03C 3/68; H01T 23/00; B03C 3/41; B03C 3/86; B03C 3/04; B03C 2201/10

(57) ABSTRACT

An electronic air cleaner includes a control housing including an ion generation device and a brush array having at least one brush assembly extending therefrom. The brush array is connectable to the control housing in both a first configuration and a second configuration.

### CROSS-REFERENCE TO RELATED APPLICATIONS

This application claims the benefit of U.S. Application No. 63/356,779, filed Jun. 29, 2022, the contents of which are incorporated by reference herein in their entirety.

### BACKGROUND

Embodiments of the disclosure relate to the art of air treatment, and more particularly, a reversible bipolarization ionizing device.

In air conditioning systems, the air to be delivered to an area being conditioned is not only conditioned, but is also filtered or otherwise treated prior to delivery. One device commonly used to perform such treatment is an electronic air cleaner including a bipolar ionizer. A bipolar ionizer is operable to generate ions that remove particulates from the air by enhancing filtration or deposition. However, it can be difficult to position the ionizer upstream from a filter while maintaining the electrodes in a downstream orientation relative to a flow of air.

### BRIEF DESCRIPTION

According to an embodiment, an electronic air cleaner includes a control housing including an ion generation device and a brush array having at least one brush assembly extending therefrom. The brush array is connectable to the control housing in both a first configuration and a second configuration.

In addition to one or more of the features described above, or as an alternative, in further embodiments the second configuration is rotated about a longitudinal axis of the brush array relative to the first configuration.

In addition to one or more of the features described above, or as an alternative, in further embodiments the second configuration is rotated 180 degrees about a longitudinal axis of the brush array relative to the first configuration.

In addition to one or more of the features described above, or as an alternative, in further embodiments the control housing further comprises a first socket operably coupled to the ion generation device and a second socket operably coupled to the ion generation device and the brush array further comprises a first electrical plug and a second electrical plug, the first socket and the second socket being identical and the first electrical plug and the second electrical plug being identical.

In addition to one or more of the features described above, or as an alternative, in further embodiments in the first configuration, the first electrical plug is received within the first socket and the second electrical plug is received within the second socket.

In addition to one or more of the features described above, or as an alternative, in further embodiments in the second configuration, the second electrical plug is received within the first socket and the first electrical plug is received within the second socket.

In addition to one or more of the features described above, or as an alternative, in further embodiments the brush array further comprises a cover, the cover being operable to seal the control housing when the brush array is connected to the control housing.

In addition to one or more of the features described above, or as an alternative, in further embodiments the cover is symmetrical about a central longitudinal axis of the cover.

In addition to one or more of the features described above, or as an alternative, in further embodiments the cover is symmetrical about a perpendicular horizontal axis of the cover.

In addition to one or more of the features described above, or as an alternative, in further embodiments the cover further comprises a plurality of flanges, the control housing being receivable between the plurality of flanges when the control housing is coupled to the brush array.

In addition to one or more of the features described above, or as an alternative, in further embodiments each of the plurality of flanges is C-shaped.

In addition to one or more of the features described above, or as an alternative, in further embodiments the brush array is connectable to the control housing via a snap fit connection.

In addition to one or more of the features described above, or as an alternative, in further embodiments the control housing further comprises at least one connector having an opening formed therein and the at least one brush array further comprises at least one engagement post, the at least one engagement post being receivable within the opening to couple the brush array to the control housing.

In addition to one or more of the features described above, or as an alternative, in further embodiments the at least one brush assembly further comprises a plurality of brush assemblies, each of the plurality of brush assemblies including at least one electrode.

In addition to one or more of the features described above, or as an alternative, in further embodiments of the plurality of brush assemblies includes a plurality of electrodes.

In addition to one or more of the features described above, or as an alternative, in further embodiments a total number of electrodes of the plurality of brush assemblies is between four electrodes and twenty electrodes.

In addition to one or more of the features described above, or as an alternative, in further embodiments the brush array further comprises a brush arm having at least one opening formed therein, the at least one brush assembly extending through the at least one opening.

In addition to one or more of the features described above, or as an alternative, in further embodiments comprising a retaining ring mounted to the brush arm coaxially with the at least one opening, the at least one brush assembly being receivable within the retaining ring such that at least a portion of the at least one brush assembly extends beyond the retaining ring.

### BRIEF DESCRIPTION OF THE DRAWINGS

The following descriptions should not be considered limiting in any way. With reference to the accompanying drawings, like elements are numbered alike:

FIG. 1 is a perspective view of an exemplary electronic air cleaner according to various embodiments;

FIG. 2 is an exploded perspective view of the electronic air cleaner of FIG. 1 according to various embodiments;

FIG. 3 is a side view of the electronic air cleaner of FIG. 1 according to various embodiments;

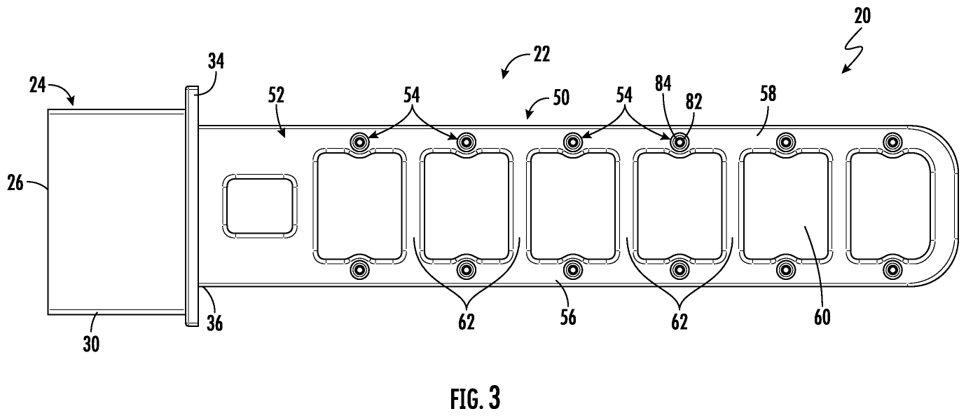

FIG. 4 is a schematic diagram of an electronic air cleaner according to various embodiments; and

FIG. 5 is a perspective view of a brush array of an electronic air cleaner according to various embodiments.

### DETAILED DESCRIPTION

A detailed description of one or more embodiments of the disclosed apparatus and method are presented herein by way of exemplification and not limitation with reference to the Figures.

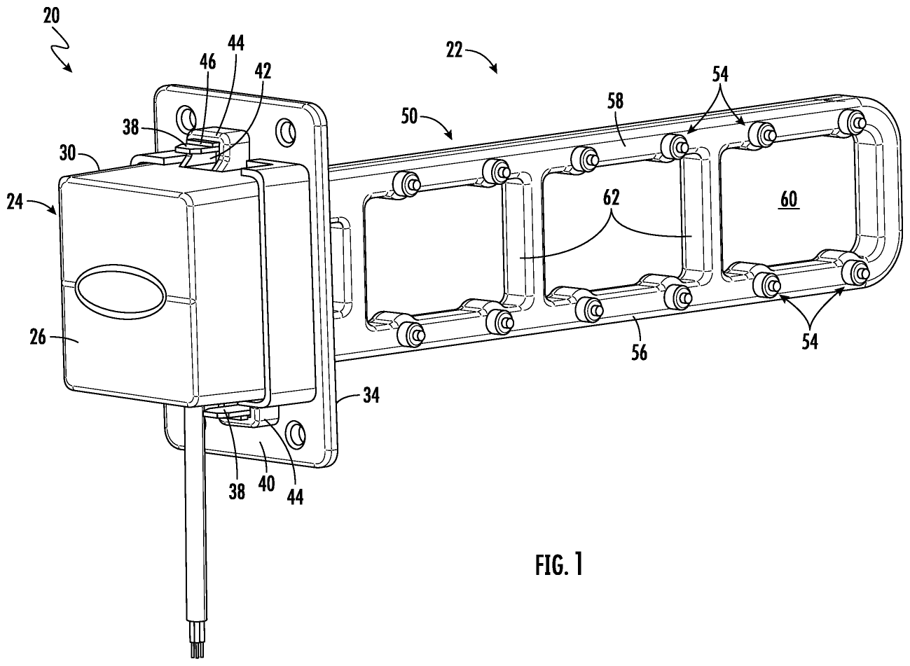

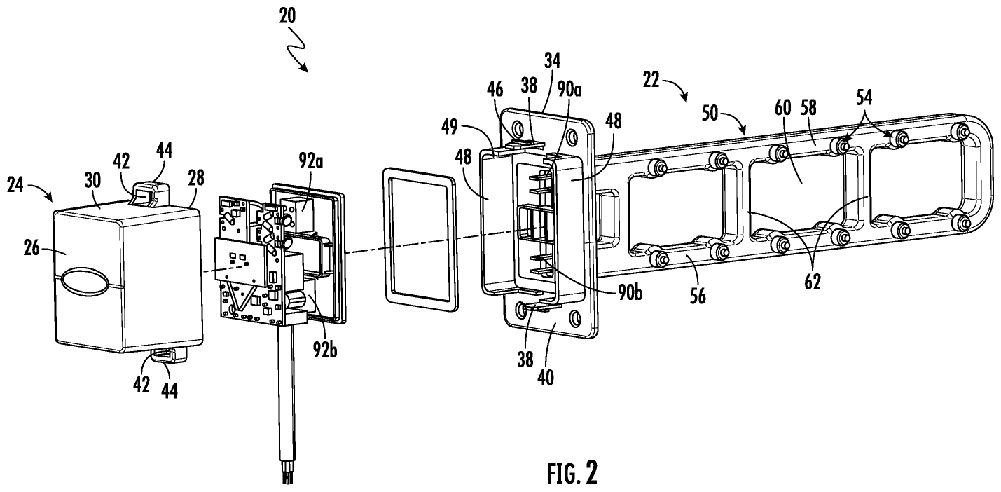

With reference to FIG. 1, an exemplary electronic air cleaner 20 is illustrated. As shown, the air cleaner includes a brush array 22 and a control housing 24. In the illustrated, non-limiting embodiment, the control housing 24 includes a closed first end 26, and open second end 28, and a plurality of sidewalls 30 extending between the first end 26 and the second end 28 such that a hollow interior or cavity 32 (see FIG. 2) is defined therebetween.

A cover 34 is configured to mount to the distal end of the plurality of sidewalls 30 to substantially seal the second open end 28 of the cavity 32. In an embodiment, the cover 34 is arranged at a first end 36 of the brush array 22. The cover 34 may be removably coupled to the control housing 24, such as via a plurality of fasteners, a snap fit connection, or in any other suitable manner. Alternatively, the cover 34 may be permanently affixed to the control housing 24.

To form a snap fit connection, at least one engagement post 38 may extend from a first surface 40 of the cover 34, such as in a direction away from the brush array 22 for example. In the illustrated, non-limiting embodiment, the cover 34 includes two substantially identical engagement posts 38 mounted along a central longitudinal axis of the cover 34. Further, the engagement posts 38 may be formed to be resilient or allow some flexure thereof. When the cover 34 is mounted to the control housing 24, each of the engagement posts 38 is received within a corresponding opening 42 formed in the control housing 24. As shown, the control housing 24 has two connectors 44 arranged opposite one another and each connector 44 has an opening 42 formed therein. The engagement post 38 may include a ridge 46 or other area where the thickness is greater than the remainder of the engagement post 38. When the engagement post 38 is received within the opening 42, the ridge 46 will abut a surface of the connector 44 adjacent to the opening 42, thereby restricting movement of the cover 34 relative to the control housing 24. It should be understood that although two engagement posts 38 and connectors 44 are shown, any number of engagement posts 38 and connectors 44 are within the scope of the disclosure and further that the engagement posts 38 and connectors 44 may be arranged at any suitable location.

In an embodiment, the cover 34 additionally or alternatively includes one or more flanges 48 extending from the first surface 40 of the cover 34 in a direction away from the brush array 22. Although two flanges are shown, any number of flanges including a single flange and more than two flanges are also contemplated herein. The plurality of flanges 48 may be substantially identical and symmetrically positioned about the central longitudinal axis of the cover 34. Although the flanges 48 are shown as being generally C-shaped, embodiments where the flanges have another configuration are also within the scope of the disclosure. It should be appreciated that the configuration of the flange may vary based on the total number of flanges 48. As illustrated in FIG. 1, when the cover 34 is mounted to the control housing 24, the sidewalls 30 of the control housing 24 are arranged between and are configured to abut an interior surface 49 of each of the flanges 48.

The brush array 22 additionally includes a brush arm 50 extending from the cover 34 in a direction opposite the engagement post 38 and/or flange 48. As shown, the brush arm 50 may be arranged substantially orthogonal to the cover 34. However, embodiments where the brush arm 50 has another orientation relative to the cover 34 are within the scope of the disclosure. In an embodiment, the brush arm 50 is a separate component fixedly or removably mounted to the cover 34. In another embodiment, the brush arm 50 is integrally formed with the cover 34.

In the illustrated, non-limiting embodiment, the brush arm 50 includes a body or structural member 52 capable of supporting at least one brush assembly 54. The brush arm 50 may be formed as a single unitary body, or alternatively, may be formed by connecting multiple components, such as an upper portion and a lower portion for example. As shown, the body 52 may have a first member 56 and second member 58 arranged parallel to one another and separated by a clearance 60. The first and second members 56, 58 may be connected at a distal end thereof, as shown, such that the body 52 is generally U-shaped. Further, the first and second members 56, 58 may be substantially identical and/or the thickness of the body 52, measured perpendicular to the longitudinal axis of the body 52, may be constant or may vary. It should be understood that embodiments where the brush arm 50 has another configuration, such as a circular configuration for example, are also contemplated herein.

In some embodiments, such as where the body 52 is configured to support a plurality of brush assemblies 54 and therefore is generally elongated in the longitudinal direction, the brush arm 50 may additionally one or more cross-members 62 that span the clearance 60 to connect the first member 56 and the second member 58. Inclusion of a cross-member 62 may increase the structural rigidity of the body 52. The cross-members 62 may be separate components or may be integrally formed with one or both of the first and second members 56, 58. It should be understood that the electronic air cleaner 20 illustrated and described herein is intended as an example only, and that an electronic air cleaner having any suitable configuration is within the scope of the disclosure.

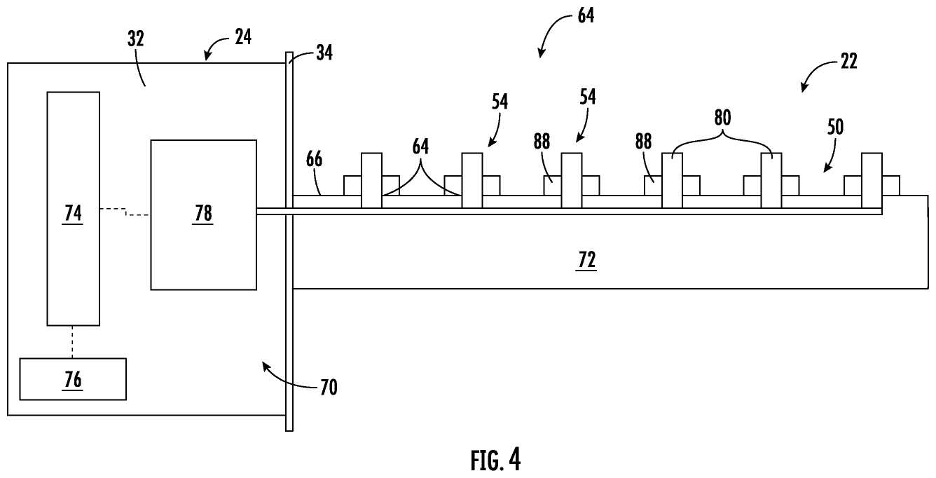

A plurality of openings or bores 64 (shown in FIG. 4) are formed in an upper surface 66 of body 52. The total number of openings 64 will vary based on the total number of brush assemblies 54. Although the openings 64 are formed in both of the first and second members 56, 58 and each opening 64 is axially aligned with at least one opening on the same member and at least one opening on the opposite members, embodiments where the openings 64 are not aligned with one another are also contemplated herein. In an embodiment, the distance between openings 64 formed in the same arm may be between about 20 mm and 60 mm. Alternatively, or in addition, the distance between a first opening 64 formed in the first arm and a second opening formed in the second arm and being axially aligned with the first opening may be between about 20 mm and about 60 mm.

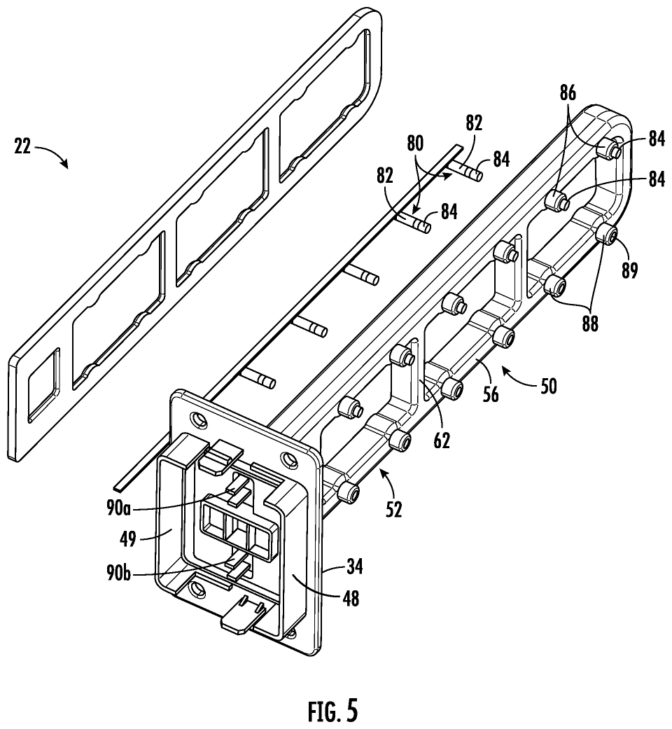

In an embodiment, the electronic air cleaner 20 additionally includes an ionizing system 70 (see FIG. 5). All or a portion of the ionizing system 70 may be arranged within the cavity 32 of the control housing 24. At least part of the body 52 of the brush arm 50, such as the first member 56 and the second member 58 for example, has a hollow interior 72. Accordingly, in an embodiment, a portion of the ionizing system 70 is arranged within the body 52 of the brush arm 50, such as within hollow interior 72. The ionizing system 70 may include a circuit board 74 and a power supply 76 operably coupled to the circuit board 74 to provide power to one or more components of the air cleaner 20. The ionizing system 70 may additionally include an ion generation device 78 that is operably coupled to the circuit board 74 and that is configured to receive power therefrom to produce ions.

The one or more brush assemblies 54, such as the array of brush assemblies for example, are connected to the ion generation device 78. Each brush assembly 54 includes at least one electrode or high voltage wire 80 that extends through the hollow interior 72 of the body 52 and respective opening 64 formed in the body 52 of the brush arm 50. In embodiments where a brush assembly 54 includes two electrodes 80, the electrodes are mounted via two separate respective openings 64, such as an opening 64 in the first member 56 and an axially aligned opening 64 in the second member 58. However, embodiments where the two electrodes 80 are mounted to the same portion of the body 52, such as the same arm for example, are also contemplated herein.

In an embodiment (see FIG. 5), a plurality of electrodes may be arranged in an array. Each electrode 80 contains a brush 82 including a plurality of bristles 84 that extend outwardly from a distal end of the brush 82. The brush 82 may be made of any suitable material that conducts electricity. In the illustrated, non-limiting embodiment, the ionizing system 70 includes six brush assemblies 54, each having two electrodes 80. However, embodiments where the ionizing system 70 includes any number of brush assemblies 54 each including one or more electrodes 80 is within the scope of the disclosure. For example, a total number of electrodes 80 of the air cleaner 20 may be between four electrodes and twenty electrodes.

As previously noted, when the electrodes 80 are mounted relative to the body 52 of the brush arm 50, the electrodes 80 extend through the openings 64, generally perpendicularly to the surface 66 of the body 52. In an embodiment, the distance between the surface 66 of the body 52 and a distal end of at least one electrode 80, and in some embodiments the plurality of electrodes 80, is between about 0.25 mm and about 10 mm, such as between about 0.03 mm and about 7 mm, and between about 0.5 mm and about 4 mm for example.

In an embodiment, shown in FIG. 5, a collar or retaining ring 88 is mounted generally adjacent to the surface 66 of the body 52, coaxially with an opening 64. The collar 88 has a central opening 89 with a diameter generally equal to the diameter of the opening 64 such that a portion of the electrode 80 is receivable therein. The collar 88 may be affixed to the body 52 and/or to an electrode 80 in any suitable manner. In an embodiment, an axial length of the collar 88 extending in a direction parallel to the electrode 80 and generally perpendicular to the first and second members 56, 58 is selected such that only the distal end of the bristles 84 extend beyond the collar 88. In instances where the electrodes 80 have an elongated configuration, inclusion of a collar 88 provides structural support to the brush 82 to maintain the bristles 84 in a desired position.

With continued reference to FIG. 5 and further reference to FIG. 2, in an embodiment, the brush array 22 is connectable to the control housing 24 and to the ionizing system 70 contained within the interior 32 of the control housing 24 in both a first configuration and a second configuration. In the illustrated, non-limiting embodiment, the brush array 22 is rotated 180 degrees between the first configuration (FIG. 5) and the second configuration. As shown, a plurality of electrical plugs 90, such as a first electrical plug 90a and a second electrical plug 90b for example, extend from the first surface 40 of the cover 34. In an embodiment, the plurality of electrical plugs are substantially identical. The electrical plugs 90a, 90b may, but need not be centered about the central longitudinal axis of the cover 34. Accordingly, in an embodiment, the cover 34 and the components extending from the first surface 40 thereof are symmetrical about both the central longitudinal axis of the cover 34 and a perpendicular horizontal axis of the cover 34.

A portion of the ionizing system 70 operably coupled to the ion generation device 78 is configured to couple to the brush array 22. The portion includes a plurality of sockets 92 corresponding to the plurality of electrical plugs 90, such as a first socket 92a and a second socket 92b for example. When the brush array 22 is in the first configuration, the first electrical plug 90a is receivable within the first socket 92a and the second electrical plug 90b is receivable within the second socket 92b. Similarly, when the brush array 22 is in the second configuration, the second electrical plug 90b is receivable within the first socket 92a and the first electrical plug is receivable within the second socket 92b. The second configuration is rotated relative to the first configuration about a longitudinal axis of the electronic air cleaner 20. In an embodiment, the second configuration is rotated 180 degrees about the longitudinal axis.

By allowing the brush arm to connect to the control housing and the ionizing system 70 in a plurality of configurations, the brush arm 50 may be installed with the plurality of electrodes 80 arranged in either an upstream configuration (first configuration) or a downstream configuration (second configuration) relative to an airflow being cleaned by the electronic air cleaner 20. Accordingly, there is no longer a need for separate electronic air cleaners 20 having an upstream and downstream configuration, respectively.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electronic air cleaner comprising:
a control housing including an ion generation device; and
a brush array having at least one brush assembly extending therefrom, wherein the brush array is connectable to the control housing in both a first configuration and a second configuration.

2. The electronic air cleaner of claim 1, wherein the second configuration is rotated about a longitudinal axis of the brush array relative to the first configuration.

3. The electronic air cleaner of claim 1, wherein the second configuration is rotated 180 degrees about a longitudinal axis of the brush array relative to the first configuration.

4. The electronic air cleaner of claim 1, wherein the control housing further comprises a first socket operably coupled to the ion generation device and a second socket operably coupled to the ion generation device and the brush array further comprises a first electrical plug and a second electrical plug, the first socket and the second socket being identical and the first electrical plug and the second electrical plug being identical.

5. The electronic air cleaner of claim 4, wherein in the first configuration, the first electrical plug is received within the first socket and the second electrical plug is received within the second socket.

6. The electronic air cleaner of claim 4, wherein in the second configuration, the second electrical plug is received within the first socket and the first electrical plug is received within the second socket.

7. The electronic air cleaner of claim 1, wherein the brush array further comprises a cover, the cover being operable to seal the control housing when the brush array is connected to the control housing.

8. The electronic air cleaner of claim 7, wherein the cover is symmetrical about a central longitudinal axis of the cover.

9. The electronic air cleaner of claim 8, wherein the cover is symmetrical about a perpendicular horizontal axis of the cover.

10. The electronic air cleaner of claim 7, wherein the cover further comprises a plurality of flanges, the control housing being receivable between the plurality of flanges when the control housing is coupled to the brush array.

11. The electronic air cleaner of claim 10, wherein each of the plurality of flanges is C-shaped.

12. The electronic air cleaner of claim 1, wherein the brush array is connectable to the control housing via a snap fit connection.

13. The electronic air cleaner of claim 12, wherein the control housing further comprises at least one connector having an opening formed therein and the at least one brush array further comprises at least one engagement post, the at least one engagement post being receivable within the opening to couple the brush array to the control housing.

14. The electronic air cleaner of claim 1, wherein the at least one brush assembly further comprises a plurality of brush assemblies, each of the plurality of brush assemblies including at least one electrode.

15. The electronic air cleaner of claim 14, wherein each of the plurality of brush assemblies includes a plurality of electrodes.

16. The electronic air cleaner of claim 14, wherein a total number of electrodes of the plurality of brush assemblies is between four electrodes and twenty electrodes.

17. The electronic air cleaner of claim 1, wherein the brush array further comprises a brush arm having at least one opening formed therein, the at least one brush assembly extending through the at least one opening.

18. The electronic air cleaner of claim 17, further comprising a retaining ring mounted to the brush arm coaxially with the at least one opening, the at least one brush assembly being receivable within the retaining ring such that at least a portion of the at least one brush assembly extends beyond the retaining ring.
